(19) United States
(12) Patent Application Publication
(10) Pub. No.: US 2016/0154929 A1
(43) Pub. Date: Jun. 2, 2016

(54) NEXT GENERATION SEQUENCING ANALYSIS SYSTEM AND NEXT GENERATION SEQUENCING ANALYSIS METHOD THEREOF

(71) Applicant: Institute For Information Industry, Taipei (TW)

(72) Inventors: Shao-Hua CHENG, Taipei City (TW); Yu Shian CHIU, Taoyuan City (TW); Eric Y. CHUANG, Taipei City (TW); Tzu-Pin LU, Taipei City (TW); Heng-Yuan TUNG, Zhongli City (TW)

(21) Appl. No.: 14/605,029

(22) Filed: Jan. 26, 2015

(30) Foreign Application Priority Data
Dec. 1, 2014 (TW) 103141576

(51) Int. Cl. G06F 19/22

(52) U.S. Cl. CPC G06F 19/22

(57) ABSTRACT

A next generation sequencing analysis system and a next generation sequencing analysis method thereof are provided. The next generation sequencing analysis system receives a target gene input, and decides at least one gene group of the target gene input based on gene related information stored in a gene database. The next generation sequencing analysis system adjusts a standard gene reference sequence into a featured gene reference sequence according to the at least one gene group, and compares a plurality of pieces of under-test gene fragment information with the featured gene reference sequence to obtain a gene variation rate

### PRIORITY

This application claims priority to Taiwan Patent Application No. 103141576 filed on Dec. 1, 2014, which is hereby incorporated by reference in its entirety.

### FIELD

The present invention relates to a next generation sequencing analysis system and a next generation sequencing analysis method thereof. More particularly, the next generation sequencing analysis system and the next generation sequencing analysis method thereof according to the present invention mainly take a featured standard gene sequence as a basis for gene comparison.

### BACKGROUND

As compared to the conventional gene sequencing method, the next generation sequencing method can shorten the sequencing time more effectively and reduce the sequencing cost under the assistance of an improved chemical sequencing mechanism and the gene automatic engineering.

However, in the next generation sequencing method and the process of variation analysis thereof, all under-test gene samples must be compared with a standard gene reference sequence used as a standard. The number of sites of the standard gene reference sequence frequently amounts to hundreds of millions. Therefore, the average analysis time per piece of gene information is as long as 12-24 hours if the current next generation sequencing method and the variation analysis mechanism are adopted.

Although there are already some related algorithms and hardware specially designed to accelerate the sequencing and analysis for the next generation sequencing method, most of such algorithms for improving performances have poor practicability and improving the hardware levels would represent a significant increase in the cost, so there is still a great bottleneck in improving the processing efficiency of the current next generation sequencing method.

Accordingly, an urgent need exists in the art to provide a solution capable of utilizing the existing resources to effectively improve the processing efficiency of the next generation sequencing method and the analysis result.

### SUMMARY

A primary objective of the present invention includes providing a next generation sequencing analysis method for a next generation sequencing analysis system. The next generation sequencing analysis system connects to a gene database. The next generation sequencing analysis method in certain embodiments may comprise: (a) enabling the next generation sequencing analysis system to receive a target gene input; (b) enabling the next generation sequencing analysis system to decide at least one gene group of the target gene input according to gene related information stored in the gene database; (c) enabling the next generation sequencing analysis system to adjust a standard gene reference sequence stored in the gene database into a featured gene reference sequence according to the at least one gene group; (d) enabling the next generation sequencing analysis system to compare a plurality of pieces of under-test gene fragment information with the featured gene reference sequence; and (e) enabling the next generation sequencing analysis system to analyze a gene variation rate between the plurality of pieces of under-test gene fragment information and the featured gene reference sequence.

To achieve the aforesaid objective, certain embodiments of the present invention include a next generation sequencing analysis system, which comprises a transmission interface, an input interface, a memory and a processing unit. The transmission interface is configured to connect to a gene database, which comprises gene related information and a standard gene reference sequence. The input interface is configured to receive a target gene input. The memory has a plurality of pieces of under-test gene fragment information therein. The processing unit is configured to: decide at least one gene group of the target gene input according to gene related information; adjust the standard gene reference sequence into a featured gene reference sequence according to the at least one gene group; compare the plurality of pieces of under-test gene fragment information with the featured gene reference sequence; and analyze a gene variation rate between the plurality of pieces of under-test gene fragment information and the featured gene reference sequence.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a next generation sequencing analysis system according to a first embodiment of the present invention;

FIG. 1B is a schematic view of gene grouping according to the first embodiment of the present invention;

FIG. 1C is a schematic view of reference sequence featuring according to the first embodiment of the present invention;

FIG. 1D is a schematic view illustrating comparisons between under-test gene fragment information and a featured gene reference sequence according to the first embodiment of the present invention; and

FIG. 2 is a flowchart diagram of a next generation sequencing analysis method according to a second embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

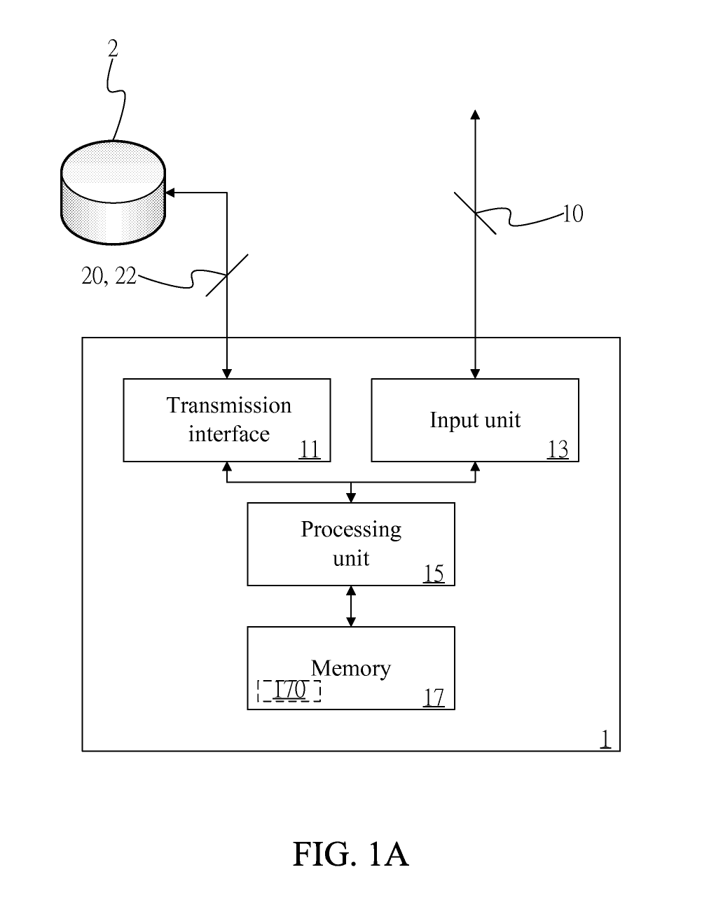

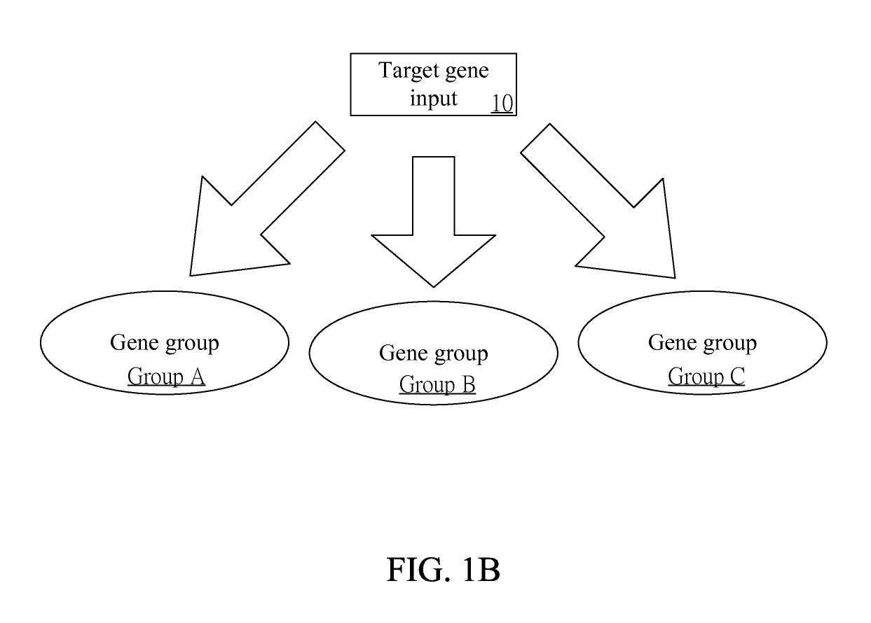

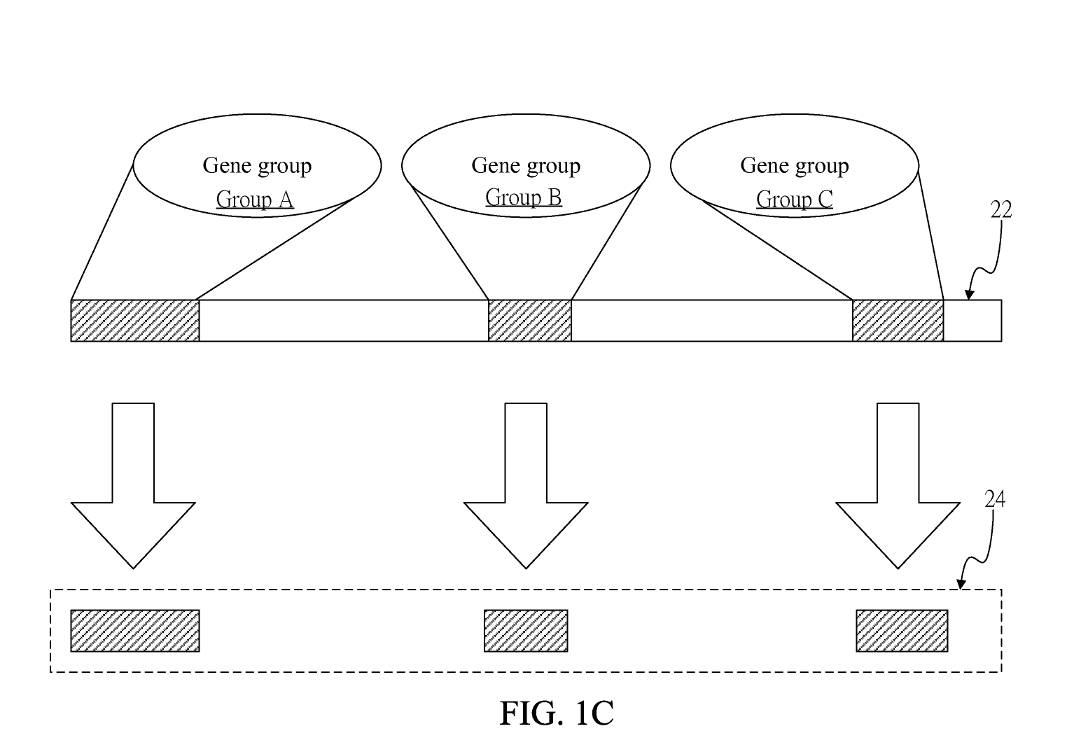

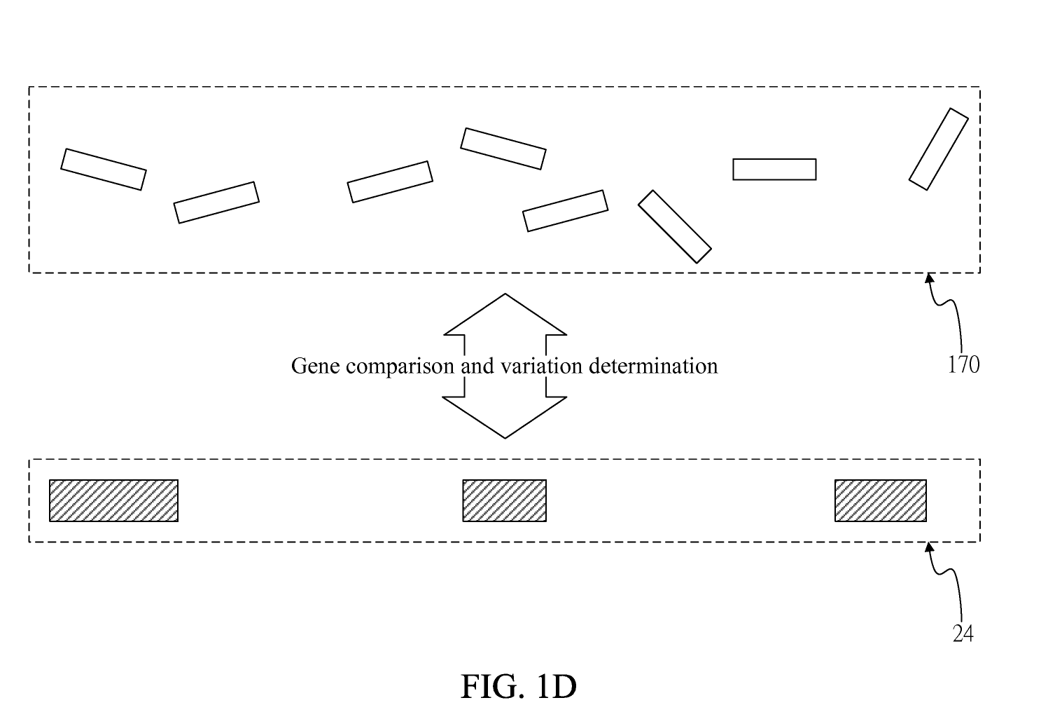

Referring to FIG. 1A, there is shown a schematic view of a next generation sequencing analysis system 1 according to a first embodiment of the present invention. The next generation sequencing analysis system 1 comprises a transmission interface 11, an input unit 13, a processing unit 15 and a memory 17. The transmission interface 11 connects to a gene database 2 so as to retrieve gene related information 20 and a standard gene reference sequence 22 (e.g., UCSC HG19 reported by the University of California) stored in the gene database 2. The memory 17 has a plurality of pieces of under-test gene fragment information 170 therein. The process of the next generation sequencing analysis will be further illustrated hereinafter.

Firstly, the user may operate the next generation sequencing analysis system 1 with respect to gene information on which he or she wants to make a research and an analysis. Specifically, the user inputs a target gene input 10, which comprises the gene subject to be analyzed, into the next generation sequencing analysis system 1. Then, the input unit 13 of the next generation sequencing analysis system 1 receives the target gene input 10.

Referring to FIG. 1B together, there is shown a schematic view of gene grouping according to the first embodiment of the present invention. Specifically, the processing unit 15 of the next generation sequencing analysis system 1 decides at least one gene group Groups A, B, C of the target gene input 10 according to the gene related information 20 recorded in the gene database 2. In detail, because the gene related information 20 mainly records structures of various levels, common operations and functions or the like information related to gene proteins, the next generation sequencing analysis system 1 may determine the genes related to the gene subject of the target gene input 10 accordingly, and group the genes.

For example, supposing that the user wants to make a research on gene AKT3 which is highly related to the breast cancer, the user may decide AKT3 as the target gene input. Then, because the gene related information comprises gene family related information, the next generation sequencing analysis system can determine a gene family (e.g., AKT1, AKAP13, ANLN) to which the AKT3 belongs, and group the related genes recorded by the gene family of AKT3.

Similarly, the gene related information may also comprise gene pathway related information, and accordingly, the next generation sequencing analysis system may determine a gene pathway

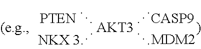

to which the AKT3 belongs and group the related genes that are on the gene pathway of AKT3. Further speaking, the next generation sequencing analysis system may further enlarge the range of grouping for the genes of the gene family of AKT3 and the gene pathways that the genes pass through respectively according to both the gene family and the gene pathways.

Thereby, in the aforesaid manner, the gene group highly related to the target gene input can be obtained. It should be particularly appreciated that, the number of the gene groups of the first embodiment is three; however, it is not intended to limit the number of the gene groups, and the exemplary example described above is not intended to limit the gene related information to the gene family and the gene pathway. People skilled in the art shall readily understand, from the content of the present invention, that the gene related information may also comprise gene related information customized by the user or obtained through his or her own research and the number of the gene groups varies with different genes due to different gene related information.

Further, the grouping manner described above is mainly accomplished through the correlations between the gene family and the gene pathway. However, it is not intended to limit the manner of gene grouping either; and how to apply the technology adopting different grouping algorithms (e.g., the k-means grouping algorithm) in the present invention to accomplish the gene grouping for gene clusters of the target gene input shall be readily understood by people skilled in the art, so this will not be further described herein.

Referring next to FIG. 1C together, there is shown a schematic view of reference sequence featuring according to the first embodiment of the present invention. Specifically, after having determined the gene groups Group A, B, C of the target gene input 10, the processing unit 15 of the next generation sequencing analysis system 1 adjusts the standard gene reference sequence 22 into a featured gene reference sequence 24 accordingly.

Further speaking, because each of the gene groups Group A, B, C comprises genes represented by itself, the processing unit 15 of the next generation sequencing analysis system 1 may select a corresponding gene section from the standard gene reference sequence 22 according to the contents of the gene groups Group A, B, C, and screen it into the featured gene reference sequence 24. In other words, the featured gene reference sequence 24 is mainly the reference sequence derived based on the gene groups Group A, B, C of the target gene input 10.

Referring to FIG. 1D, there is shown a schematic view of comparisons between the under-test gene fragment information and the featured gene reference sequence according to the first embodiment of the present invention. Then, the processing unit 15 of the next generation sequencing analysis system 1 may compare the under-test gene fragment 170 with the featured gene reference sequence 24, and analyze a gene variation rate (not depicted) between the under-test gene fragment 170 and the featured gene reference sequence 24 according to the comparison result. It should be particularly appreciated that, because the technologies of sequencing, comparison and analysis between the under-test gene fragment and the reference sequence are well known to people skilled in the art, they will not be further described herein.

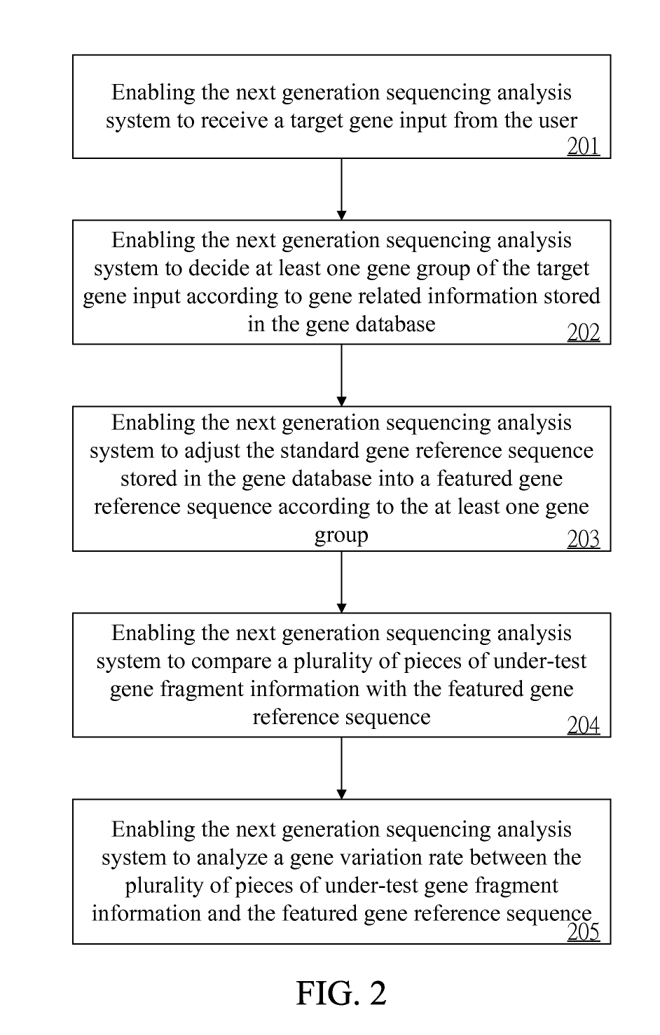

A second embodiment of the present invention is a next generation sequencing analysis method, a flowchart diagram of which is shown in FIG. 2. The method of the second embodiment is for use in a next generation sequencing analysis system (e.g., the next generation sequencing analysis system 1 of the embodiment described above). The next generation sequencing analysis system connects to a gene database, and the gene database stores gene related information and a standard gene reference sequence. Detailed steps of the second embodiment are described as follows.

Firstly, step 201 is executed to enable the next generation sequencing analysis system to receive a target gene input inputted by the user. The target gene input comprises the gene information on which the user wants to make a research and an analysis. Then, step 202 is executed to enable the next generation sequencing analysis system to decide at least one gene group of the target gene input according to the gene related information stored in the gene database.

Likewise, because the gene related information may comprise correlation information of the gene family, the gene pathway or the customized gene group, the aforesaid step of deciding at least one gene group may be accomplished mainly according to the correlation information between the gene family, the gene pathway or the customized gene group. Similarly, the method of gene grouping may be accomplished through use of the technologies of different grouping algorithms (e.g., the k-means grouping algorithm).

Then, step 203 is executed to enable the next generation sequencing analysis system to adjust the standard gene reference sequence stored in the gene database into a featured gene reference sequence according to the at least one gene group. In other words, for gene contents of the at least one gene group, the corresponding sections on the standard gene reference sequence are screened out to form the featured gene reference sequence.

Step 204 is executed to enable the next generation sequencing analysis system to compare a plurality of pieces of under-test gene fragment information with the featured gene reference sequence. Finally, step 205 is executed to enable the next generation sequencing analysis system to analyze a gene variation rate between the plurality of pieces of under-test gene fragment information and the featured gene reference sequence.

According to the above descriptions, the next generation sequencing analysis system and the next generation sequencing analysis method of the present invention may firstly group the genes according to the genes to be analyzed, and form the standard gene reference sequence into a featured gene reference sequence by use of the grouped genes. In other words, the standard gene reference sequence is significantly simplified into the featured gene reference sequence so that subsequent sequencing, analyzing and variation searching operations can be performed on only the featured gene reference sequence that has a shorter length, thus effectively shortening the analysis and process time of the gene information.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A next generation sequencing analysis method for a next generation sequencing analysis system, the next generation sequencing analysis system connecting to a gene database, the next generation sequencing analysis method comprising:
(a) the next generation sequencing analysis system receiving a target gene input;
(b) the next generation sequencing analysis system deciding at least one gene group of the target gene input according to gene related information stored in the gene database;
(c) the next generation sequencing analysis system adjusting a standard gene reference sequence stored in the gene database into a featured gene reference sequence according to the at least one gene group;
(d) the next generation sequencing analysis system comparing a plurality of pieces of under-test gene fragment information with the featured gene reference sequence; and
(e) the next generation sequencing analysis system analyzing a gene variation rate between the under-test gene fragment information and the featured gene reference sequence.

2. The next generation sequencing analysis method of claim 1, wherein the gene related information comprises gene family information, and the step (b) includes:
(b1) the next generation sequencing analysis system deciding the at least one gene group of the target gene input according to the gene family information stored in the gene database.

3. The next generation sequencing analysis method of claim 1, wherein the gene related information comprises gene pathway information, and the step (b) includes:
(b1) the next generation sequencing analysis system deciding the at least one gene group of the target gene input according to the gene pathway information stored in the gene database.

4. The next generation sequencing analysis method of claim 1, wherein the step (b) includes:
(b1) the next generation sequencing analysis system deciding the at least one gene group of the target gene input through a grouping algorithm according to the gene related information stored in the gene database.

5. A next generation sequencing analysis system, comprising:
a transmission interface, being configured to connect to a gene database, wherein the gene database comprises gene related information and a standard gene reference sequence;
an input interface, being configured to receive a target gene input;
a memory, having a plurality of pieces of under-test gene fragment information therein;
a processing unit, being configured to:
decide at least one gene group of the target gene input according to gene related information;
adjust the standard gene reference sequence into a featured gene reference sequence according to the at least one gene group;
compare the under-test gene fragment information with the featured gene reference sequence; and
analyze a gene variation rate between the under-test gene fragment information and the featured gene reference sequence.

6. The next generation sequencing analysis system of claim 5, wherein the gene related information comprises gene family information, and the processing unit decides the at least one gene group of the target gene input according to the gene family information.

7. The next generation sequencing analysis system of claim 5, wherein the gene related information comprises gene pathway information, and the processing unit decides the at least one gene group of the target gene input according to the gene pathway information.

8. The next generation sequencing analysis system of claim 5, wherein the processing unit decides the at least one gene group of the target gene input through a grouping algorithm according to the gene related information stored in the gene database.
